(19) United States
(12) Patent Application Publication
(10) Pub. No.: US 2006/0203132 A1
(43) Pub. Date: Sep. 14, 2006

(54) Device and method of color adjustment for projection type video image display devices

(76) Inventors: Adrianus Johannes Stephanes Maria De Vaan, Eindhoven (NL); Willem Hendrik Smits, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/539,975

(22) PCT Filed: Nov. 17, 2003
(86) PCT No.: PCT/IB03/05266

§ 371 Date: Jun. 19, 2005

(30) Foreign Application Priority Data
Dec. 17, 2002 (EP) 02080400.1

(51) Int. Cl. H04N 5/64; H04N 9/31

(52) U.S. Cl. 348/744

(57) ABSTRACT

The present invention relates to the field of projection type video image display devices allowing color adjustment and a method for such a color adjustment. The device comprises a light source (1) for emitting a white light luminous flux; color light-separating means (2a, 2b) for separating the white light into three color lights of red, blue and green light; light valves (3R, 3G, 3B) for modulating lights contained in luminous fluxes from said color light-separating means (2a, 2b), and producing a video image; color light-combining means (4) for combining the modulated luminous fluxes, and projection optical means (5) for projecting a combined luminous flux on a screen. At least one dichroic filter (10, 10a, 10b, 10c) having characteristics for selectively passing and selectively reflecting any one of the red, blue or green light is arranged at least partially insertable into and retrievable from the optical path of said white light luminous flux, providing means for adjusting the color of the combined luminous flux.

### FIELD OF THE INVENTION

The present patent application relates to the field of projection type video image display devices, and particularly to a projection type video image display device allowing color adjustment as well as a method for such a color adjustment.

### BACKGROUND OF THE INVENTION

Today, many projection type video image display devices having three liquid crystal light valves for modulating red light, blue light and green light are unable to perform a color reproduction which complies with the standard put forward by the European Broadcasting Union (EBU). This especially applies to reproduction of the standard D65 white point, a reason why the resulting video images are often far from optimal.

One prior-art approach is disclosed in JP 2001174774, which suggests a projection type video image display device which can be switched between a display mode with high luminance and a high quality color reproduction mode. According to this prior-art approach, rays from a light source are condensed by integrator lenses and a lens and spectrally divided into three primary colors by dichroic mirrors to illuminate three liquid crystal panels, and the modulated rays are synthesized by a dichroic prism and projected by a projecting lens onto a screen. A filter having such characteristics that it cuts the edge part of the wavelength range of each color of the three primary colors is inserted into the optical path prior to the spectral division for the high-quality reproduction of colors so that the liquid crystal panel is irradiated with light of colors with high purity. For the image display with high luminance, the filter is retrieved from the optical path so that the liquid crystal panel is irradiated with rays in the whole wavelength range of each color.

However, this prior-art approach only allows a predetermined color purity correction.

### OBJECT AND SUMMARY OF THE INVENTION

Accordingly, it is an object of the present invention to provide an improved projection type video image display device allowing selective color adjustment.

This object is achieved by providing at least one dichroic filter having characteristics for selectively passing and selectively reflecting any one of the red, blue or green light such that it is at least partially insertable into and retrievable from an optical path for a white light luminous flux within said projection type video image display device.

Another object of the invention is to provide an improved method for selective color adjustment in a projection type video image display.

This object is achieved by a method of providing at least one dichroic filter having characteristics for selectively passing and selectively reflecting any one of the red, blue or green light such that it is at least partially insertable into and retrievable from an optical path for a white light luminous flux within said projection type video image display device.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 discloses a schematic view of a projection type video image display device according to a general embodiment of the invention;

FIG. 2 discloses a schematic view of a first embodiment of the filter setup of the projection type video image display device according to the general embodiment of the invention according to FIG. 1;

FIG. 3 discloses a schematic view of a second embodiment of the filter setup of the projection type video image display device according to the general embodiment of the invention according to FIG. 1;

FIG. 4 discloses a schematic view of a third embodiment of the filter setup of the projection type video image display device according to the general embodiment of the invention according to FIG. 1;

FIG. 5 discloses a schematic view of a fourth embodiment of the filter setup of the projection type video image display device according to the general embodiment of the invention according to FIG. 1.

### DETAILED DESCRIPTION OF EMBODIMENTS

In the following description, the invention will be elucidated and exemplified with reference to a three-light valve projection type display device. However, the present invention is also applicable to single-light valve projection type display devices. These single-light valve projection type display devices include, but are not restricted to: projection systems containing a single transmissive Liquid Crystal Display (LCD) light valve with a mosaic color filter pattern; projection systems containing a reflective Digital Micromirror Device (DMD) light valve with sequential color generation, e.g. color wheel; projection systems containing a reflective Liquid Crystal On Semiconductor (LCOS) light valve with sequential color generation, e.g. color wheel or scrolling bar; projection systems comprising a transmissive light valve containing a micro lens array or a micro color filter pattern; projection systems comprising a light valve arranged to be time-sequentially illuminated with lights of different colors or illuminated by colored light spots sweeping over the light valve; and projection systems comprising a light valve containing an array of optical elements arranged to focus light of different colors on different pixels of the light valve. The present invention is also applicable to monochrome projection systems, e.g. black and white projection systems, to change the white color.

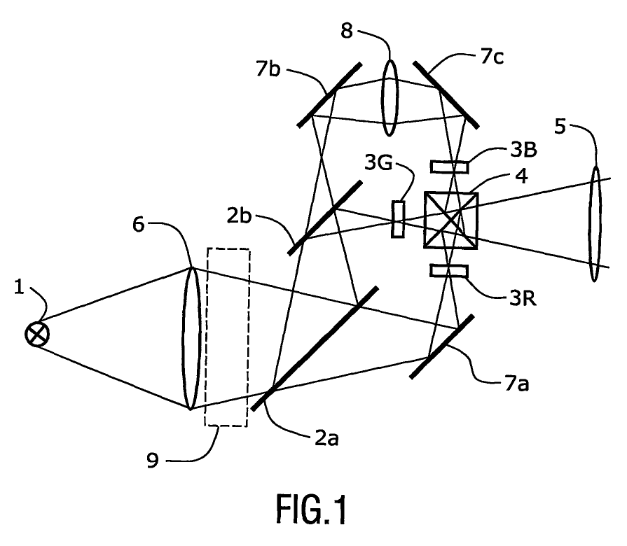

FIG. 1 is a conceptual diagram showing a basic constitution of a projection type display device according to a general embodiment suited for application of the present invention. The projection type display device mainly comprises a light source 1, such as a halogen lamp, a metal halide lamp, an ultrahigh pressure mercury-vapor lamp, or a similar lamp. Furthermore, it comprises color light-separating means 2a, 2b such as dichroic mirrors, for separating a white color luminous flux emitted therefrom into color luminous fluxes of the three primaries, red, blue and green. Three liquid crystal light valves 3R, 3G, 3B are provided for optically modulating the separated luminous fluxes of each respective color. Color light-combining means 4 are provided, such as a dichroic prism, for combining the modulated luminous fluxes of the optically modulated colors through these liquid crystal light valves 3R, 3G, 3B. A projection lens 5 is provided for magnifying and projecting the combined modulated luminous flux on a projection screen (not shown). The optical paths of the luminous fluxes are illustrated in FIG. 1, using thin solid lines.

The process until an image is magnified and projected on the projection screen is described below.

A white light luminous flux emitted from the light source 1 passes through an illuminating optical system composed of a first lens 6, and goes toward a first dichroic mirror 2a which passes red light and reflects green and blue light.

The red light passing through the first dichroic mirror 2a is reflected by a first reflection mirror 7a, and reaches liquid crystal light valve modulating means 3R. The green light is reflected by a second dichroic mirror 2b which reflects green light and passes blue light, and reaches liquid crystal light valve modulating means 3G.

The blue light passes through the second dichroic mirror 2b, and is reflected by a second reflection mirror 7b, is brought through a first relay lens 8, and is reflected by a third reflection mirror 7c, and reaches liquid crystal light valve modulating means 3B. Herein, the color lights modulated by the liquid crystal light valve modulating means 3R, 3G, 3B according to a video signal corresponding to the colors are put into the dichroic prism color light combining means 4.

Color lights modulated according to the video signal corresponding to the colors by the liquid crystal light valve modulating means 3R, 3G, and 3B are combined by the dichroic prism color light-combining means 4, and projected on a projection screen (not shown) through a projection lens 5 which is a projection-optical means.

In order to facilitate color adjustment of the projection type display device, at least one dichroic spatially defined color selective filter having characteristics for selectively passing and selectively reflecting any one of the red, blue or green light is arranged at least partially insertable into and retrievable from the optical path of said white light luminous flux, preferably in the area defined by the frame 9, illustrated by broken lines in FIG. 1.

Through insertion of such a filter, the pupil size for any one color can be reduced, such that the illumination angle on the associated liquid crystal light valve modulating means 3R, 3G, 3B is reduced with respect to this color. E.g. if a filter or pair of filters are partially inserted, such that the pupil size for blue and green light is reduced, i.e. the filter partially reflects the contribution of blue and green light in said white luminous flux, the color will normally be adjusted so that a shift of the resulting white color towards the desired D65 white point will occur.

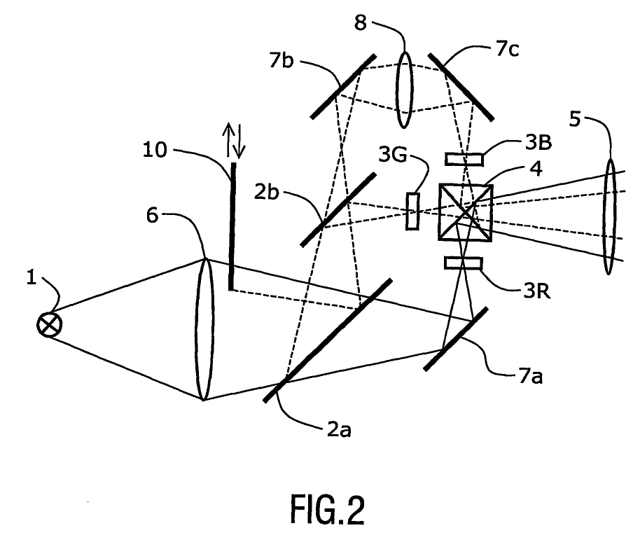

FIG. 2 illustrates a first embodiment of the filter setup where one filter 10, as illustrated, or several separate filters for reflecting any one or each of the red, blue and green light are arranged at least partially insertable into and retrievable from the optical path of said white light luminous flux from one side thereof, e.g. either insertable into the optical path of said white luminous flux in a horizontal or vertical direction or any arbitrary direction therebetween. The filter illustrated in FIG. 2 is preferably one reflecting blue and green light. Thereby, the illumination angle on the liquid crystal light valve modulating means 3B, 3G for blue light and green light will be reduced as illustrated by the dotted lines of FIG. 2, which illustrates the optical paths of these color light fluxes.

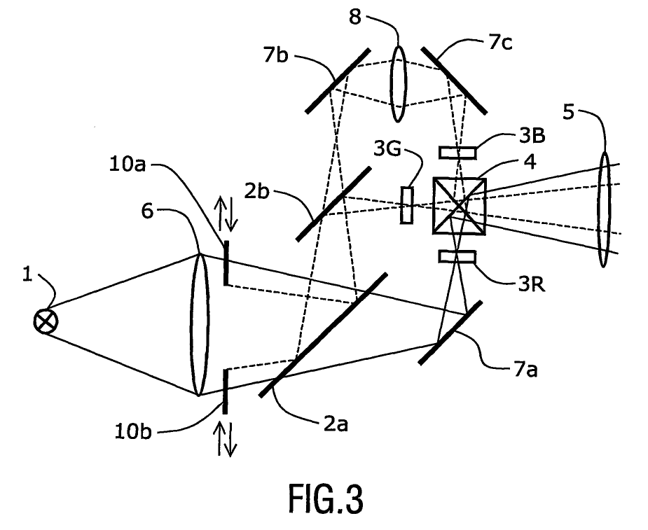

FIG. 3 illustrates an alternative embodiment of the filter setup where each filter, here illustrated by one filter, is comprised of at least two members 10a, 10b arranged to be simultaneously insertable into and retrievable from the optical path of said white light luminous flux from different sides thereof. Thereby, the light flux towards the liquid crystal light valve modulating means 3R, 3G, 3B can be reduced for any one of the red, blue or green light or any combination thereof by adjusting the corresponding filter members 10a, 10b of each filter closer to each other, adjusting a slit opening therebetween. Once again, the filter illustrated in FIG. 3 is preferably one reflecting blue and green light. Thereby, the illumination angle on the liquid crystal light valve modulating means 3B, 3G for blue and green light will be reduced as illustrated by the dotted lines in FIG. 3, which illustrates the optical paths of these color light fluxes.

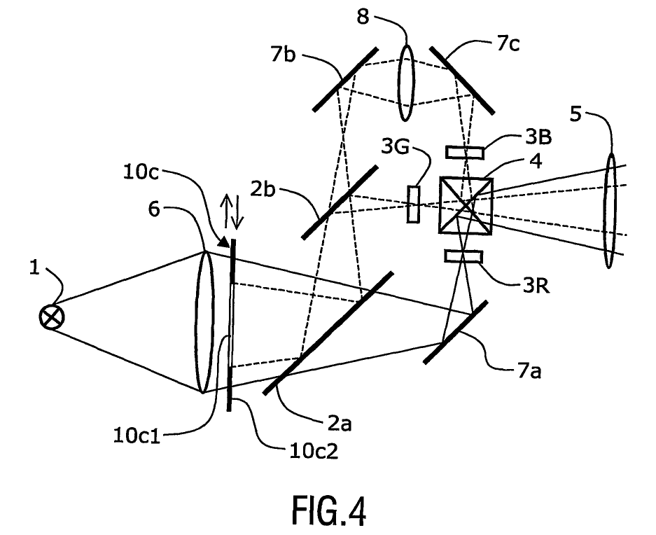

FIG. 4 illustrates a further alternative embodiment of the filter setup where each filter, here illustrated by one filter 10c, is arranged to be fully insertable into the optical path of said white light luminous flux. According to this embodiment, each filter 10c comprises a central white light transmittant area 10c1 surrounded by an area 10c2 reflecting any one of the red, blue or green light or any combination of two or more of these color lights. Thereby, an opening for passing white light is provided and at the same time the light flux towards the liquid crystal light valve modulating means 3R, 3G, 3B can be reduced for any one of the red, blue or green light or any combination thereof through inserting a corresponding filter 10c or a combination of filters fully into the path of said white luminous flux. The relationship between the central white light transmittant area 10c1 and the surrounding reflecting area 10c2 is preferably adapted in such a way that the color contribution renders a white point equal to the standard D65 white point. However, as will be obvious to the person skilled in the art, this arrangement can also be used to adjust the white color point of the projection type display device towards other values. By stacking several filters, the contribution of each color can be precisely adjusted and the illumination angles can be optimized for each color channel towards a preferred system white point. Again, the filter illustrated in FIG. 4 is preferably one reflecting blue and green light. Thereby, the illumination angle on the liquid crystal light valve modulating means 3B, 3G for blue and green light will be reduced as illustrated by the dotted lines in FIG. 4, which illustrates the optical paths of these color light fluxes.

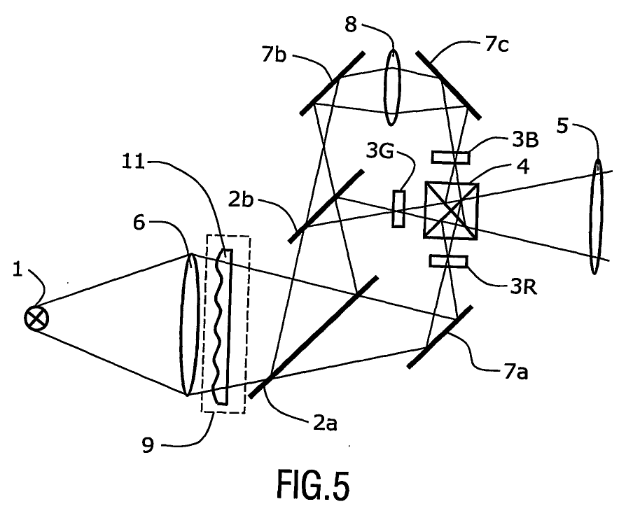

FIG. 5 illustrates a further alternative embodiment of the filter setup where the projection type video image display device further comprises integrator optics 11, e.g. a plate lens-integrator or a rod integrator, arranged in the optical path of said white light luminous flux. According to this embodiment, said filter or filters are arranged in the proximity of said integrator optics 11, preferably in the area defined by the frame 9, illustrated by broken lines in FIG. 5. In the case of a plate lens-integrator, the filter or filters can be arranged immediately before or after said plate lens-integrator or even in such a way that one or more filters are arranged upstream of said plate lens-integrator and one or more filters are arranged downstream of said plate lens-integrator, viewed in the direction of said white luminous flux. Alternatively, in the case of a rod integrator, the filter or filters can be arranged at the entrance opening of said rod integrator.

A method will be described hereinafter for color adjustment of a projection type video image display device comprising: a light source 1 for emitting a white light luminous flux in one direction, color light-separating means 2a, 2b for separating the white light from said light source 1 into three color lights of red, blue and green light, modulating means 3R, 3G, 3B comprising liquid crystal light valves for modulating lights contained in luminous fluxes from said color light-separating means 2a, 2b, and producing a video image, color light-combining means 4 for combining the modulated luminous fluxes after being modulated by said modulating means 3R, 3G, 3B, and projection-optical means 5 for projecting a combined luminous flux obtained by said color light-combining means 4 on a projection screen. According to any one of the embodiments described above, the method comprises the step of: providing at least one dichroic spatially defined color selective filter having characteristics for selectively passing and selectively reflecting any one of the red, blue or green light such that it is at least partially insertable into and retrievable from the optical path of said white light luminous flux.

In a further embodiment, the method further comprises the steps of providing integrator optics 11 in the path of said white light luminous flux and arranging said filter or filters in the proximity of said integrator optics.

In yet a further embodiment, the method comprises the steps of providing one separate filter for selectively passing and selectively reflecting any one of the red, blue and green light, respectively.

In a still further embodiment, the method comprises the steps of providing filters each of which is comprised of at least two members 10a, 10b arranged in such a way that they are simultaneously insertable into and retrievable from the optical path of said white light luminous flux from different sides thereof.

In an additional further embodiment, the method comprises the steps of providing a filter or filters which are arranged to be fully insertable into the optical path of said white light luminous flux where each filter comprises a central white light transmittant area 10c1 surrounded by an area 10c2 reflecting any one of the red, blue or green light or any combination of two or more of these color lights.

In yet further embodiments, the method comprises the step of providing modulating means comprising two or three light valves.

In still further embodiments, the method comprises the step of providing modulating means comprising a transmissive light valve containing either a microlens array or a microcolor pattern.

In yet additional further embodiments, the method comprises the step of providing means for illuminating said light valve either time-sequentially with lights of different colors or by colored light-spots sweeping over said light valve.

In still an additional further embodiment, the method comprises the step of providing modulating means comprising a light valve containing an array of optical elements arranged to focus light of different colors on different pixels on said light valve.

As illustrated above, a projection type video image display device and a method for color adjustment of a projection type video image display device have been described, where selective color adjustment is easily achievable. The general advantages of commonly occurring projection type video image display devices are largely retained, as when the filter or filters are retrieved fully from the optical path, no light is blocked and the liquid crystal light valve modulating means are irradiated with the full luminous flux, providing a high luminance display. The approach according to the present invention is advantageous in comparison with the previously discussed prior-art approach, which only allows a predetermined color purity correction through full insertion of wavelength restricting filters. The present invention eliminates these restrictions of such a prior-art approach by providing selective color adjustment in projection type video image display devices.

Thus, while fundamental novel features of the invention as applied to a preferred embodiment thereof have been shown, described and pointed out, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A projection type video image display device comprising: a light source (1) for emitting a white light luminous flux in one direction, modulating means comprising at least one light valve (3R, 3G, 3B) for modulating light contained in said luminous flux and producing a video image, and projection optical means (5) for projecting said modulated luminous flux on a screen, wherein at least one dichroic filter (10, 10a, 10b, 10c) having characteristics for selectively passing and selectively reflecting any one of the red, blue or green light is arranged at least partially insertable into and retrievable from the optical path of said white light luminous flux.

2. The projection type video image display device of claim 1, further comprising: color light-separating means (2a, 2b) for separating the white light from said light source into three color lights of red, blue and green light, said modulating means comprising light valves (3R, 3G, 3B) for modulating lights contained in luminous fluxes from said color light-separating means (2a, 2b) and producing a video image, color light-combining means (4) for combining the modulated luminous fluxes after being modulated by said modulating means, said projection optical means (5) for projecting a combined luminous flux being obtained by said color light combining means (4) on said screen.

3. The projection type video image display device of claim 1, further comprising integrator optics (11) arranged in the optical path of said white light luminous flux wherein said filter or filters (10, 10a, 10b, 10c) are arranged in the proximity of said integrator optics (11).

4. The projection type video image display device of claim 1, wherein one filter (10) is provided for selectively passing and selectively reflecting any one of the red, blue and green light, respectively.

5. The projection type video image display device of claim 1, wherein each filter is comprised of at least two members (10a, 10b) arranged to be simultaneously insertable into and retrievable from the optical path of said white light luminous flux from different sides thereof.

6. The projection type video image display device of claim 1, wherein each filter (10c) is arranged to be fully insertable into the optical path of said white light luminous flux and each filter (10c) comprises a central white light transmittant area (10c1) surrounded by an area (10c2) reflecting any one of the red, blue or green light or any combination of two or more of these color lights.

7. The projection type video image display device of claim 1, wherein said modulating means comprises two light valves.

8. The projection type video image display device of claim 1, wherein said modulating means comprises three light valves.

9. The projection type video image display device of claim 1, wherein said modulating means comprises a transmissive light valve containing a microlens array.

10. The projection type video image display device of claim 1, wherein said modulating means comprises a transmissive light valve containing a microcolor filter pattern.

11. The projection type video image display device of claim 1, wherein said modulating means comprises a light valve arranged to be time-sequentially illuminated with lights of different colors.

12. The projection type video image display device of claim 1, wherein said modulating means comprises a light valve arranged to be illuminated by colored light-spots sweeping over said light valve.

13. The projection type video image display device of claim 1, wherein said modulating means comprises a light valve containing an array of optical elements arranged to focus light of different colors on different pixels of said light valve.

14. A method for color adjustment of a projection type video image display device comprising: a light source for emitting a white light luminous flux in one direction, modulating means comprising at least one light valve for modulating light contained in said luminous flux and produce a video image, and projection optical means for projecting said modulated luminous flux on a screen, wherein said method comprises the step of:
providing at least one dichroic filter having characteristics for selectively passing and selectively reflecting any one of the red, blue or green light such that it is at least partially insertable into and retrievable from the optical path of said white light luminous flux.

15. The method of claim 14, further comprising the steps of providing: color light-separating means for separating the white light from said light source into three color lights of red light, blue light and green light, modulating means comprising light valves for modulating lights contained in luminous fluxes from said color light-separating means and producing a video image, color light-combining means for combining the modulated luminous fluxes after being modulated by said modulating means, and projection-optical means for projecting a combined luminous flux obtained by said color light-combining means on a screen.

16. The method of claim 14, further comprising the steps of providing integrator optics in the optical path of said white light luminous flux and arranging said filter or filters in the proximity of said integrator optics.

17. The method of claim 14, further comprising the steps of providing one filter for selectively passing and selectively reflecting any one of the red, blue and green light, respectively.

18. The method of claim 14, further comprising the steps of providing filters each of which is comprised of at least two members arranged in such a way that they are simultaneously insertable into and retrievable from the optical path of said white light luminous flux from different sides thereof.

19. The method of claim 14, further comprising the steps of providing filters which are arranged to be fully insertable into the optical path of said white light luminous flux where each filter comprises a central white light transmittant area surrounded by an area reflecting any one of the red, blue or green light or any combination of two or more of these color lights.

20. The method of claim 14, further comprising the step of providing modulating means comprising two light valves.

21. The method of claim 14, further comprising the step of providing modulating means comprising three light valves.

22. The method of claim 14, further comprising the step of providing modulating means comprising a transmissive light valve containing a microlens array.

23. The method of claim 14, further comprising the step of providing modulating means comprising a transmissive light valve containing a microcolor filter pattern.

24. The method of claim 14, further comprising the step of providing means for time-sequentially illuminating said light valve with lights of different colors.

25. The method of claim 14, further comprising the step of providing means for illuminating said light valve by colored light-spots sweeping over said light valve.

26. The method of claim 14, further comprising the step of providing modulating means comprising a light valve containing an array of optical elements arranged to focus light of different colors on different pixels of said light valve.
